(19) United States
(12) Patent Application Publication
(10) Pub. No.: US 2021/0130924 A1
(43) Pub. Date: May 6, 2021

(54) SYSTEMS AND METHODS FOR RECOVERING SCRAP SILVER

(71) Applicant: Coby Tao, Tucson, AZ (US)

(72) Inventor: Coby Tao, Tucson, AZ (US)

(21) Appl. No.: 16/675,001

(22) Filed: Nov. 5, 2019

(51) Int. Cl. C22B 3/00; C22B 7/00

(52) U.S. Cl. CPC C22B 11/046; C22B 7/007

(57) ABSTRACT

A method of recovering scrap silver. The method includes obtaining scrap sources that include silver. The method also includes submerging the scrap sources in an aqueous solution of hydrofluoric acid (HF). The method further includes adding hydrogen peroxide (H₂O₂) to the aqueous solution of hydrofluoric acid to create a leachate. The method additionally includes extracting silver from the leachate.

### CROSS-REFERENCE TO RELATED APPLICATIONS

Not applicable.

### BACKGROUND OF THE INVENTION

As the world moves toward ever more connectivity more electronic devices are being produced. While these devices provide many benefits, they also produce a waste stream. That waste stream can be toxic in many settings. In addition, some of the materials used in electronic devices are becoming more expensive because of scarcity. Because of these problems, there is increased interest in recovering the materials used in electronic devices.

One of the materials that can be recovered is silver. Silver is used in many ways: as a precious metal bullion, in jewelry, electronics, medical devices, photography, solar panels, and much more. But silver is a limited resource. The U.S. Geological Survey estimates the global reserves of silver at 530,000 tons. In 2017, the global silver production was about 25,000 tons. At current production rates, we would see the known reserves of silver depleted within the next 25 years.

According to the Silver Institute, the global industrial demand for silver represented nearly 60% of the silver production in 2017. Specifically, the solar industry represented 9.25% of the total silver demand in 2017, up from 7.6% in 2016 and 5.1% in 2015. Today, each silicon solar cell contains about 0.1 grams of silver. This is the equivalent of about $0.05 of silver per solar cell at today's price for silver, $0.55 a gram. The biggest silicon solar cell manufacturer, Jinko Solar, produced about 1,500,000,000 silicon solar cells in 2018. This is the equivalent of about 150 tons or $82M silver that could be recycled just when these solar cells reach their end-of-life. This does not include other silicon solar cell manufacturers or other sources of silver for recovery.

However, the current processes for doing so have a number of drawbacks. The current electrowinning process for silver recovery from scraps uses nitric acid (HNO₃) to dissolve silver. This process does not allow the regeneration of the leaching solution and produces toxic nitric oxide and/or nitrous oxide gases (NO and NO₂) in the dissolution step. The current process also suffers from a low silver recovery rate (which is approximately 65%). This is due partially to the fact that electrowon silver will redissolve in the leaching solution.

Accordingly, there is a need in the art for a silver recovery method with high recovery rates. Further, there is a need in the art for silver recovery method and system that regenerates the leaching solution for reuse and does not produce toxic gases.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a method of recovering scrap silver. The method includes obtaining scrap sources that include silver. The method also includes submerging the scrap sources in an aqueous solution of hydrofluoric acid (HF). The method further includes adding hydrogen peroxide (H₂O₂) to the aqueous solution of hydrofluoric acid to create a leachate. The method additionally includes extracting silver from the leachate.

Another example embodiment includes a method of recovering scrap silver. The method includes obtaining scrap sources that include silver. The method also includes submerging the scrap sources in an aqueous solution of hydrofluoric acid. The method further includes adding hydrogen peroxide to the aqueous solution of hydrofluoric acid to create a leachate. The addition of hydrogen peroxide catalyzes the dissolution of silver and produces oxygen bubbling as a byproduct of the dissolution of silver. The method additionally includes determining when the solution has stopped bubbling. When the solution has stopped bubbling adding additional hydrogen peroxide and determining whether the reaction is continuing. If the reaction is continuing, returning to the step of determining when the solution has stopped bubbling. If the reaction is not continuing, extracting silver from the leachate.

Another example embodiment includes a method of recovering scrap silver. The method includes obtaining scrap sources that include silver. The method also includes submerging the scrap sources in an aqueous solution of hydrofluoric acid. The method further includes adding hydrogen peroxide to the aqueous solution of hydrofluoric acid to create a leachate. The addition of hydrogen peroxide catalyzes the dissolution of silver and produces oxygen bubbling as a byproduct of the dissolution of silver. The method additionally includes determining when the solution has stopped bubbling. When the solution has stopped bubbling adding additional hydrogen peroxide and determining whether the reaction is continuing. If the reaction is continuing, returning to the step of determining when the solution has stopped bubbling. If the reaction is not continuing, extracting silver from the leachate using an electrowinning system.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting its scope. The invention will be described and explained with additional specificity and detail through the use of the accompanying drawings in which:

FIG. 1 is a flowchart illustrating a method of recovering scrap silver;

FIG. 2 is a flowchart illustrating a method of extracting silver from a leachate;

FIG. 3 illustrates an alternative method of extracting silver from a leachate; and

FIG. 4 illustrates an example of an electrowinning system.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting the present invention, nor are they necessarily drawn to scale.

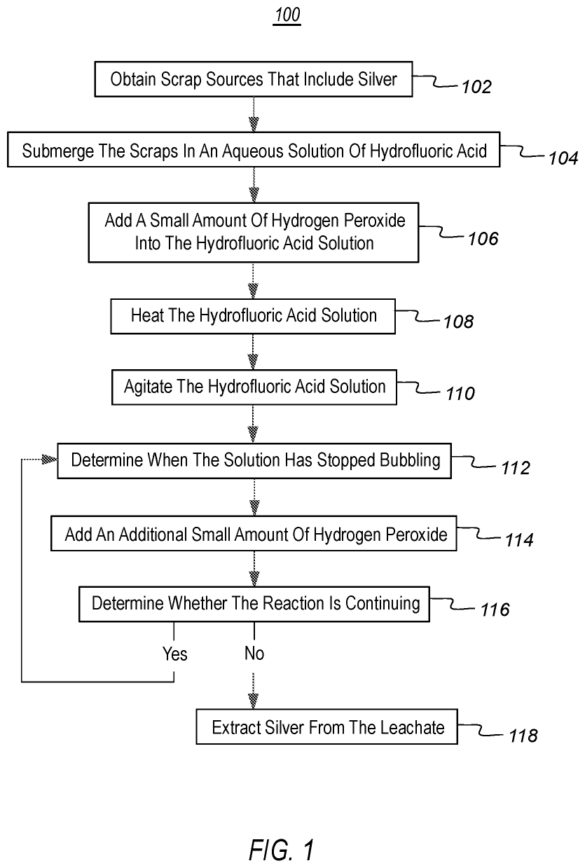

FIG. 1 is a flowchart illustrating a method 100 of recovering scrap silver. The scrap silver can be recovered from a variety of sources. For example, the silver can be recovered from silicon solar cells, silicon solar panels, electronic wastes, etc. The silver is recovered in a metallic form and at a high purity level.

FIG. 1 shows that the method 100 can include obtaining 102 scrap sources that include silver. Any scrap source that includes silver can be used. The scrap source can be preprocessed to first recover other materials and/or can be processed after the method 100 is complete to recover other materials. That is, the method 100 is able to work on scrap sources that have already been processed or will later be processed, since this process targets silver extraction and most of the other materials remain. Thus, a user can determine where the method 100 fits in the overall procedure if other processing is to be done.

FIG. 1 also shows that the method 100 can include submerging 104 the scraps in an aqueous solution of hydrofluoric acid. Submerging 104 for many scrap materials will occur naturally as the scraps will often be denser than the hydrofluoric acid because of the presence of silver and other metals. Hydrofluoric acid is a solution of hydrogen fluoride (HF) in water and is very corrosive. The concentration of hydrofluoric acid can be between 0.1 wt % and 20 wt %. Although the hydrofluoric acid is corrosive, there should be no observable reaction with silver at this time.

FIG. 1 further shows that the method 100 can include adding 106 a small amount of hydrogen peroxide (H₂O₂) into the hydrofluoric acid solution. Hydrogen peroxide is normally used in an aqueous solution. After adding 106 the hydrogen peroxide, the solution will then begin to bubble. If a large amount of H₂O₂ is added, the solution will bubble violently, splashing hazardous chemicals; thus, it must be added slowly. Therefore, the term “small amount” means about 1 mL of 30 wt % H₂O₂ per 1 gram of silver in the hydrofluoric acid solution. The H₂O₂ catalyzes the dissolution of Ag and formation of silver fluoride (AgF) with the reaction:

2Ag(s)+3H₂O₂(l)+2HF(aq)→4H₂O(l)+2AgF(aq)+O₂(g)

Because of the potential for splashing, covers may be placed over the container into which the scraps were submerged 104.

FIG. 1 also shows that the method 100 can include heating 108 the hydrofluoric acid solution. One of skill in the art will appreciate that heating 108 may not be necessary, but heating 108 increases the rate at which the reaction proceeds. That is, heating 108 the hydrofluoric acid solution makes the reaction proceed faster than if it was occurring at ambient temperature. However, even without heating 108 the reaction will proceed.

FIG. 1 further shows that the method 100 can include agitating 110 the hydrofluoric acid solution. Just as with heating 108, agitation 110 can cause the reaction to proceed faster, but the reaction proceeds without agitation 110. Agitation 110 can include stirring, such as with a magnetic stir bar. Likewise, agitation 110 can include shaking (in a closed container) or any other method that causes the solution to mix.

FIG. 1 additionally shows that the method 100 can include determining 112 when the solution has stopped bubbling. The determination can be made manually or through some other detection method. For example, the determination can be made by measuring the release of oxygen. E.g., the outgassing of oxygen can be measured by the increase in oxygen content right above the hydrofluoric acid solution; therefore, when the oxygen content comes down to a normal level all outgassing has ceased.

FIG. 1 also shows that the method includes adding 114 an additional small amount of hydrogen peroxide. Adding 114 an additional small amount of hydrogen peroxide allows the reaction and formation of silver fluoride to continue to completion. That is, because of how vigorous the reaction is it needs to proceed in small steps. This avoids creating a mess or splashing corrosive chemicals.

FIG. 1 further shows that the method includes determining 116 whether the reaction is continuing. For example, if bubbling can be observed, then the reaction is continuing and if no bubbling is observed then the reaction has ended. Likewise, if oxygen is being produced then the reaction is continuing and if oxygen is not being produced then the reaction has ended. If the reaction continues, then the method returns to step 112.

FIG. 1 additionally shows that the method includes extracting 118 silver from the leachate. A leachate is any liquid that includes any extracted materials from the scrap source which has come into contact with the leaching solution. I.e., the leachate is a liquid material with the silver fluoride present. The leachate can have the non-extracted materials (i.e., the remains of the scrap source minus the now reacted silver) removed prior to extraction 118. For example, the leachate can be poured or otherwise transferred to another container while the non-extracted materials remain in the original container.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

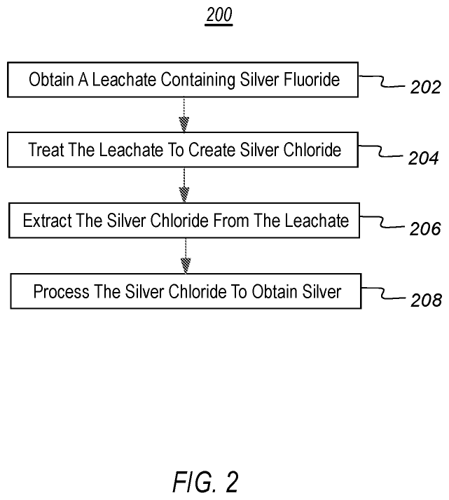

FIG. 2 is a flowchart illustrating a method 200 of extracting silver from a leachate. Extraction of silver results in metallic silver in a relatively pure form. I.e., the silver metallic has very few or no other metals present in the silver. The silver then is not chemically any different than silver from any other source and can be used as desired.

FIG. 2 shows that the method 200 can include obtaining 202 a leachate containing silver fluoride. The leachate can be obtained 202 from any desired source. For example, the leachate can be obtained 202 using the method 100 of FIG. 1. Alternatively, the leachate can be obtained using some other method.

FIG. 2 also shows that the method 200 can include treating 204 the leachate to create silver chloride (AgCl). For example, the leachate can be treated 204 with a chlorine containing chemical, such as sodium chloride (NaCl) or hydrochloric acid (HCl). Because silver chloride is insoluble in water, it will precipitate out from the leachate and can then be extracted from the leachate by filtration or sedimentation.

FIG. 2 additionally shows that the method 200 can include extracting 206 the silver chloride from the leachate. I.e., the silver chloride is removed from the leachate. The silver chloride can be extracted 206 using a mechanical process (such as filtering), a chemical process or an electrical process, as desired.

FIG. 2 further shows that the method 200 can include processing 208 the silver chloride to obtain silver. Processing 208 the silver chloride can be done using any desired method. There are many known methods for processing 208 silver chloride and any method is contemplated herein once the silver chloride is obtained as a precipitate.

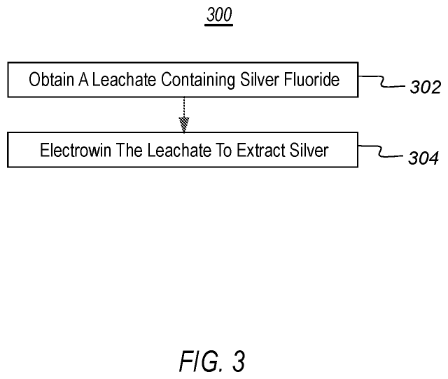

FIG. 3 illustrates an alternative method 300 of extracting silver from a leachate. Just as in the method 200 of FIG. 2, extraction of silver results in metallic silver in a relatively pure form. I.e., the silver metallic has very few or no other metals present in the silver. The silver then is not chemically any different than silver from any other source and can be used as desired.

FIG. 3 shows that the method 300 can include obtaining 302 a leachate containing silver fluoride. Just as in the method 200 of FIG. 2, the leachate can be obtained 302 from any desired source. For example, the leachate can be obtained 302 using the method 100 of FIG. 1. Alternatively, the leachate can be obtained using some other method.

FIG. 3 also shows that the method 300 can include electrowinning 304 the leachate to extract silver. Electrowinning 304 extracts metals from solutions containing these metals. In electrowinning 304, a current is passed from an anode through the leachate so that the silver is extracted as it is deposited in an electroplating process onto the cathode. A reference electrode may also be present in some instances. By applying an appropriate voltage on the cathode with respect to the reference electrode, pure silver will deposit on the cathode. During the electrowinning 304 process, hydrofluoric acid is regenerated in the solution. The hydrofluoric acid can be reused for silver recovery in the method 100 of FIG. 1. Better than 96% recovery of high-purity silver has been demonstrated by electrowinning 304.

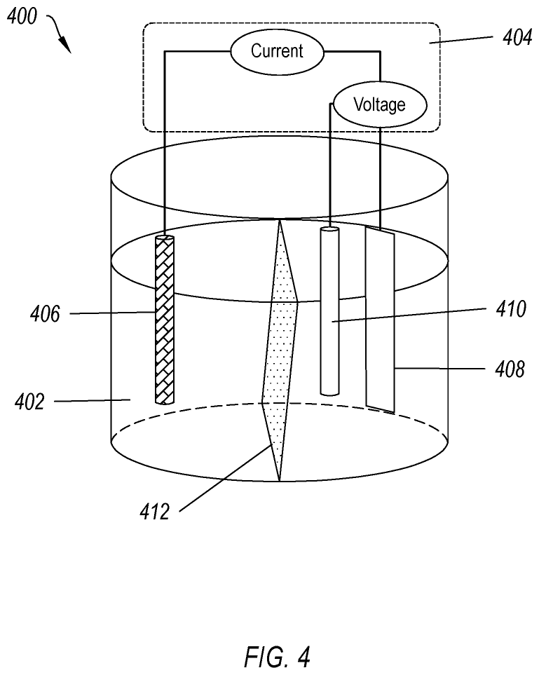

FIG. 4 illustrates an example of an electrowinning system 400. The electrowinning system 400 can be used to extract silver from a leachate. In particular, the electrowinning system 400 can remove pure silver from a leachate that contains silver, such as the leachate produced in the method 100 of FIG. 1. One of skill in the art will appreciate that the electrowinning system 400 can be used to extract other metals as well.

FIG. 4 shows that the electrowinning system 400 includes a container 402. The container 402 is used to hold an aqueous solution of hydrofluoric acid. The concentration of hydrofluoric acid can be between 0.1 wt % and 20 wt %.

In addition, scrap sources that include silver are added to the container 402. Any scrap source that includes silver can be used. For example, the silver can be recovered from silicon solar cells, silicon solar panels, electronic wastes, etc. The silver is recovered in a metallic form and at a high purity level. The scrap source can be preprocessed to first recover other materials and/or can be processed after the extraction of silver. Although the hydrofluoric acid is corrosive, there should be no observable reaction with silver at this time. The dissolution of silver takes place only after hydrogen peroxide is added to the solution. The scrap sources are submerged in the aqueous solution of hydrofluoric acid. Submerging for many scrap materials will occur naturally as the scraps will often be denser than the hydrofluoric acid because of the presence of silver and other metals.

FIG. 4 also shows that the electrowinning system 400 can include a direct current power source 404. The power source 404 creates a voltage between two electrodes. I.e., the power sources 404 creates a voltage to move electrons from one electrode to another (which results in an electric current). The power source 404 can include an electrical voltage created conventionally by using a direct current power supply or can include a battery or other power source.

If using a three-electrode system, the power source 404 can include a potentiostat, which is a specialized form of a direct current power supply. A potentiostat is the electronic hardware required to control a three-electrode system. A potentiostat functions by maintaining the voltage of a working electrode (in this case a cathode) at a constant level with respect to a reference electrode by adjusting the current at a counter electrode (in this case an anode).

FIG. 4 further shows that the electrowinning system 400 can include a counter electrode as the anode 406. The anode 406 provides electrons to the power source 404 (such as a potentiostat) by removing the electrons from one or more elements in the leaching solution or the anode. For example, the anode 406 can include graphite with a polypropylene mesh sheath, which is electrically conductive. Graphite is stable in aqueous hydrofluoric acid. However, to prevent flakes of graphite from falling into and contaminating the leaching solution, a polypropylene or fluoropolymer mesh sheath is wrapped around the graphite electrode.

FIG. 4 additionally shows that the electrowinning system 400 can include a working electrode as the cathode 408. The cathode 408 can be any metal but is preferentially silver so that the recovered silver is plated onto the silver cathode 408. The cathode receives electrons from the power source 404 (such as a potentiostat) and provides them to the silver ions in the leachate. That is, silver ions are attracted to the cathode 408 because of the negative charge of the electrons, which then creates metallic silver, in turn removing the charge and allowing more charge to flow into the cathode 408, repeating the cycle.

FIG. 4 moreover shows that the electrowinning system 400 includes a reference electrode 410. The reference electrode 410 allows a controlled voltage to be maintained by the power source 404 (such as a potentiostat). The reference electrode 410 includes any material which remains stable and chemically inactive within the aqueous hydrofluoric acid solution. For example, the reference electrode 410 can include a silver/silver chloride reference electrode or a metal electrode such as platinum, nickel, or silver.

FIG. 4 also shows that the electrowinning system 400 can include a chemically inactive sheet 412. If there is too much silver in the leachate to recover, needles of silver will grow on the cathode 408 toward the anode 406, potentially short-circuiting the system by touching the anode 406. The sheet 412 is placed between the cathode 408 and anode 406 to prevent the electrowinning system 400 from shorting. The sheet 412 can include any desired material. For example, the sheet 412 can include a polypropylene or fluoropolymer sheet.

Experimental results using an anode 406 of graphite with a polypropylene mesh sheath, a cathode 408 of silver and a reference electrode 410 comprising a silver/silver chloride electrode shows a reduction peak at −0.4 V vs. the Ag/AgCl reference electrode 410. This could be the silver reduction peak: Ag⁺(aq)+e⁻→Ag(s). In experiments, a constant voltage of −0.6 V vs. the Ag/AgCl reference electrode 410 was applied to the silver cathode 408, which resulted in silver deposition on the working electrode. Better than 96% recovery of high-purity silver has been demonstrated with the electrowinning process described herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of recovering scrap silver, the method comprising:
obtaining scrap sources that include silver;
submerging the scrap sources in an aqueous solution of hydrofluoric acid;
adding hydrogen peroxide to the aqueous solution of hydrofluoric acid to create a leachate; and
extracting silver from the leachate.

2. The method of claim 1, wherein the scrap sources include at least one of:
silicon solar cells;
silicon solar panels; or
electronic wastes.

3. The method of claim 1, wherein the concentration of the aqueous hydrofluoric acid solution is between 0.1 percent and 20 percent by weight.

4. The method of claim 1, further comprising:
heating the aqueous solution of hydrofluoric acid.

5. The method of claim 1, further comprising:
agitating the aqueous solution of hydrofluoric acid.

6. A method of recovering scrap silver, the method comprising:
obtaining scrap sources that include silver;
submerging the scrap sources in an aqueous solution of hydrofluoric acid;
adding hydrogen peroxide to the aqueous solution of hydrofluoric acid to create a leachate, wherein the addition of hydrogen peroxide:
catalyzes the dissolution of silver; and
produces oxygen bubbling as a byproduct of the dissolution of silver;
determining when the solution has stopped bubbling;
when the solution has stopped bubbling:
adding additional hydrogen peroxide;
determining whether the reaction is continuing;
if the reaction is continuing, returning to the step of determining when the solution has stopped bubbling; and
if the reaction is not continuing, extracting silver from the leachate.

7. The method of claim 6, wherein determining when the solution has stopped bubbling includes measuring the outgassing of oxygen.

8. The method of claim 6, wherein determining whether the reaction is continuing includes measuring the outgassing of oxygen.

9. The method of claim 6, wherein extracting silver from the leachate includes:
treating the leachate to create silver chloride; and
processing the silver chloride to obtain silver.

10. The method of claim 9, wherein treating the leachate to create silver chloride includes adding a chlorine containing chemical.

11. The method of claim 10, wherein the chlorine containing chemical includes sodium chloride.

12. The method of claim 10, wherein the chlorine containing chemical includes hydrochloric acid.

13. A method of recovering scrap silver, the method comprising:
obtaining scrap sources that include silver;
submerging the scrap sources in an aqueous solution of hydrofluoric acid;
adding hydrogen peroxide to the aqueous solution of hydrofluoric acid to create a leachate, wherein the addition of hydrogen peroxide:
catalyzes the dissolution of silver; and
produces oxygen bubbling as a byproduct of the dissolution of silver;
determining when the solution has stopped bubbling;
when the solution has stopped bubbling:
adding additional hydrogen peroxide;
determining whether the reaction is continuing;
if the reaction is continuing, returning to the step of determining when the solution has stopped bubbling; and
if the reaction is not continuing, extracting silver from the leachate using an electrowinning system.

14. The method of claim 13, wherein the electrowinning system includes:
a container;
a power source;
an anode; and
a cathode.

15. The system of claim 14, wherein the power source includes a potentiostat.

16. The system of claim 14, wherein the anode includes graphite with a polypropylene mesh sheath.

17. The system of claim 14, wherein the cathode includes a silver electrode.

18. The system of claim 14, wherein the electrowinning system additionally includes:
a reference electrode.

19. The system of claim 14, wherein the reference electrode includes:
a silver/silver chloride reference electrode or a platinum electrode or a nickel electrode or a silver electrode.

20. The system of claim 14, wherein the electrowinning system additionally includes:
A chemically inactive sheet between the cathode and the anode.
